(19) United States
(12) Patent Application Publication
(10) Pub. No.: US 2004/0015465 A1
(43) Pub. Date: Jan. 22, 2004

(54) Trace cognitive process model and knowledge processor

(76) Inventor: Susan P. Gill, Los Altos, CA (US)

Correspondence Address: BURNS, DOANE, SWECKER & MATHIS, L.L.P., P.O. Box 1404, Alexandria, VA, 22313-1404, US

(21) Appl. No.: 10/602,824

(22) Filed: Jun. 25, 2003

Related U.S. Application Data
(60) Provisional application No. 60/391,861, filed on Jun. 25, 2002.

(51) Int. Cl. G06F 17/00

(52) U.S. Cl. 706/50

(57) ABSTRACT

A five stage TRACE cognitive process model provides the system framework for discovering, developing, exchanging, applying, and integrating knowledge in individual and group problem-solving tasks. The user interacts with the system using a question prompt and response mode via the user interface, which is coupled to the TRACE Knowledge Processor. One embodiment of the present invention is software (local or web-based) that supply a general template with prompts to aid the user in complex creative tasks, such as preparing a plan, developing a curriculum, or designing a project. The present invention enables the users to generate and organize ideas, and finally to present their results in a format that is easily searchable, accessible, and a resource for future users of the system. The present invention enables the user to organize ideas for innovation and communication with collaborators and for assessment by team leaders or instructors.

This application claims the benefit under 35 U.S.C. 119(e) of Provisional Application Serial No. 60/391,861, filed Jun. 25, 2002, the contents of which are incorporated herein by reference in their entirety.

### FIELD OF INVENTION

This invention relates to a system and method for individually adapted learning, project development and knowledge management, as well as enabling of asynchronous collaboration among users of its knowledge processor.

### BACKGROUND OF THE INVENTION

Knowledge Processing is defined as the systematic discovery, development, exchange, and application of knowledge by humans and/or their agents. Knowledge Processors facilitate knowledge development by dialoging with the user in an interactive exchange. Research, learning/teaching, and problem solving have in the prior art been inadequately supported because of over-reliance on pre-established knowledge domain categories.

The present invention relates to knowledge-based decision support systems for solving problems. Traditionally, “expert systems” made decisions by matching user queries to a static database of information. Often specialist interaction with the expert system required answering questions in the order posed by the system, which failed to maximize the value of specialist input. While Case-Based Reasoning (CBR) addressed many of these limitations by linking problem definition to the problem solution process, the focus was still on analysis within narrow, well-defined domains.

### SUMMARY OF THE INVENTION

Embodiments of the present invention provide an organizational framework and system for passively and actively collecting information to enable users to coordinate project development for various types of projects. Embodiments can be implemented by software operating on a general purpose computer, which includes input means for entering data, means for storing, searching, and accessing data, a user interface and a means for display.

The TRACE Cognitive Process Model of one embodiment assists the user to develop innovative problem solutions and to collaborate more effectively in co-located or distributed teams. Complementary functions of positive and negative feedback are embedded in the TRACE model. Continuous survey supports continual evolution and improvement of the system. The architecture of one embodiment of the present invention is comprised of five stages, with prompts at each stage:

1. Trigger

Startup

2. Reaction

3. Action Evolution

4. Conflict

Application and Interpretation

5. Evaluation

In one embodiment of the webtank all five stages have screen displays that contain sets of categories under which are listed prompt questions. Each prompt has a pull-down menu for the reply, which is logged in sequence, enabling review of the user's problem-solving process. These five stages can repeat many times, and in any order required, during the development process:

Stage One. The Trigger in one embodiment starts the process by introducing a question framework with which to analyze problems or unsatisfactory conditions and look for “triggers for change.” In this stage users assess the present situation, inventory needs, conduct background research, ask questions to generate new ideas, and brainstorm.

Stage Two. The Reaction in one embodiment is the first bias or orientation in response to the trigger. It may be a question (to gather background information in response to the trigger) or may take the form of a probe or an action in response to the trigger. Brainstorming continues, but now the focus is on reacting to the triggers noted in the first stage, determining criteria for decision-making, and choosing a focus. Analysis and question-framing support decision-making.

Stage Three. The Action in one embodiment requires a method for interim interpretations and the choice of a methodology with which to address the problem. In this stage users define their method and organize their tools; they prepare an implementation plan and may build a prototype to test. They focus on choosing and assessing their method, planning and designing a prototype.

Stage Four. The Conflict in one embodiment is the collision of negative feedback, in various forms, which guides and redirects the evolving search process so that it converges on a fitting outcome. In this stage users learn how to lead an interim focus group or brainstorming team. The focus is on soliciting the critique of devils' advocates through leading round table or web-based focus groups.

Stage Five. The Evaluation in one embodiment determines what will become part of the outcome and what is rejected. This stage entails a final presentation and assessment of future implications and impacts. Asking questions guides assessment. The focus is on understanding the different modes of evaluation. Project owners present, while others assess whether the project presented lives up to its claims and addresses, or does not address, stated requirements. Here the form of presentation is different from the focus group presentation of the previous stage; the challenge is to persuade.

In one embodiment, this fifth stage of the TRACE model concludes one phase of the user's problem-solving process and signals a Webtank Integration Broker to support collaborative transactions, so users can bring their project ideas and find other users with whom they can work on a “bigger picture” that combines multiple projects. Complementing this active function, in the passive mode completed individual web entries are evaluated and archived with multiple mechanisms for search and matching by the Webtank Integration Broker, and a knowledge management framework to grow the knowledge bank organically.

The TRACE cognitive process model can be embedded in a range of tools, such as a collaborative web environment (webtank), software designed to support project management, or learning curriculum and its assessment. Handheld devices, and any other unit, can be used to obtain data from the user and to provide displays to the user.

In one embodiment, the TRACE framework provides an “intelligent framework” to guide and record the thought processes of users in order to support the later development of database and the continual evolution of the knowledge management functions of the Knowledge Processor. The system gives users intellectual control of their task, offering resources that combine the expertise of the user with that of the system. In one embodiment, this twofold object is embodied in a toggle function that toggles between active (user input) and passive (knowledge resource and archive) modes.

In one embodiment, users are prompted to input his goals and constraints in a structured way in order to develop innovative problem solutions and to provide the framework to enable dynamic integration of user input into an evolving shared knowledge management framework.

In one embodiment, a shared graphical user interface is provided incorporating a series of prompts to help users cover all bases and work more effectively, both independently and in teams, to generate innovative, integrated plans and new inventions. TRACE prompts support the brainstorming process of users on their projects and enable them to keep track of where they are in their problem-solving process. The interface assists the generation and maintenance of organized records to monitor and assess project progress, and to support document authoring.

In one embodiment, record-keeping is enabled in order to establish legal evidence of the priority of ideas contributed; entries are time-stamped as they are received.

In one embodiment, the system serves as a framework to structure archives and resources in order to reTRACE problem-solving processes that have occurred in this environment. Here the TRACE stages provide a framework to archive background information, while time-stamping provides a history log so that researchers can study the problem-solving process in action.

In one embodiment, the system offers an embedded continuous survey capability to assess user preferences and to analyze system effectiveness in use in order to determine where revision is needed. This continuous survey function can be used by managers, project leaders, instructors, curriculum designers, designers of collaborative web environments, marketing researchers, business strategists and others who have need of this information.

In one embodiment, the system promotes, for web-supported academic curricula, four user-driven strategies for learning: learning though speculation and play; learning by seeking information as needed (project-based learning); learning through sharing ideas in a peer-to-peer collaborative web environment; and learning through synthesis, so that each student understands where his or her contribution fits, and can be integrated, into a bigger picture.

In one embodiment, the system addresses scalability problems inherent in the growth of knowledge systems by providing a framework for distributed self-organization as the system scales up. Users add to the knowledge base of the system by archiving their project outcomes (some published into a gallery) as resources for other users.

In one embodiment, the system provides flexibly linked, process-based, overlapping knowledge categories in order to support more effective search and matching in cross-disciplinary knowledge-building, so that users can be matched with others across disciplines who have similar interests and whose skills could complement theirs. Hyperlinked data supports skill identification and collaboration, enabling users to interact with experts in other disciplines around issues that arise as they develop their projects. This framework also helps them integrate their individual projects into a larger, cross-disciplinary, collaborative framework.

In one embodiment, the system provides a framework for a process-based approach to knowledge visualization and to structure the user's process so that it can be clearly communicated to other team members, or to others in an evolving networked community of users. This capability builds on the capacity to record data entries and to use expert system technology to integrate information. By supporting users to keep track of, and to record their processes, the present invention enables them to solve problems and to collaborate more effectively in co-located or distributed teams.

Where Case-Based Reasoning relies upon analysis of previous case histories, a TRACE Knowledge Processor supports synthesis of new project plans by means of its query system and by calling upon its knowledge archives, links, and other resources.

The prior art has typically been restricted in its capacity to learn from the decision-making processes of users and to function effectively across knowledge domains because of reliance on pre-structured information and pre-established knowledge categories. A clear drawback of prior systems has been their deterministic nature, prompting the user for facts and then applying a series of rules to determine system responses.

In contrast, embodiments of the present invention provides for system evolution as the users input their knowledge into the system. Because knowledge management systems are typically structured by knowledge domain categories, they lack the capacity to link information across knowledge domains. The rapid growth of knowledge, and the need to support cross-disciplinary innovation, demands systems that can self-organize as they scale up based upon patterns of use, without being constrained by pre-established rules or knowledge domain categories.

### BRIEF DESCRIPTION OF THE DRAWINGS

The present invention is illustrated by way of example in the following drawings, which disclose various embodiments of the present invention for the purposes of illustration only and are not intended to limit the scope of the invention.

FIG. 1 is an architectural block diagram illustrating the five stages of the TRACE cognitive process model and its associated knowledge processor.

FIG. 2 is a bubble diagram showing the cyclic nature of the TRACE model and user flexibility to choose the ordering of the stages of the model.

FIG. 3 is the flow diagram illustrating an embodiment of the TRACE cognitive process model, phase one, Trigger.

FIG. 4 is the flow diagram illustrating an embodiment of the TRACE cognitive process model, phase two, Reaction.

FIG. 5 is the flow diagram illustrating an embodiment of the TRACE cognitive process model, phase three, Action.

FIG. 6 is the flow diagram illustrating an embodiment of the TRACE cognitive process model, phase four, Conflict.

FIG. 7 is the flow diagram illustrating an embodiment of the TRACE cognitive process model, phase five, Evaluation.

FIG. 8 is a block diagram of an embodiment of the complementary relationship between the passive and active roles of the TRACE cognitive process model, depending upon whether the user is searching for information (passive archive mode) or recording data (active collaboration mode). The toggle system allows the user easily to switch between modes.

### DESCRIPTION OF PREFERRED EMBODIMENTS

The following description sets out specific details to clarify present embodiments of the invention. However, those of ordinary skill in the art will appreciate that the invention may be practiced without these specific details.

The TRACE Cognitive Process Model provides the structure for a process framework that can be used independently, though it is typically embedded in a collaborative web environment (Intranet or webtank) where it supports individual work, collaborative problem-solving and also enables the process of problem-solving to be studied.

Its accompanying TRACE Knowledge Processor can be embodied in a software or web-based system to support the user to make decisions in the process of performing a task. Five knowledge storage areas, corresponding to the five stages of the TRACE Cognitive Process Model, are accessed by a knowledge interpreter.

The TRACE Cognitive Process Model provides a framework to support users to develop innovative problem solutions, both individually and in collaboration with co-located or distributed teams. It enables them to organize, record, track and assess their process. The model also provides the architecture for a its Knowledge Processor, which supports human discovery, invention, and innovation—processes of knowledge development.

The TRACE Cognitive Process Model and its associated Knowledge Processor provide a method and system for individually adapted interactive learning and problem-solving. This method provides for a series of steps and question prompts, structured by the framework of a shared graphical user interface.

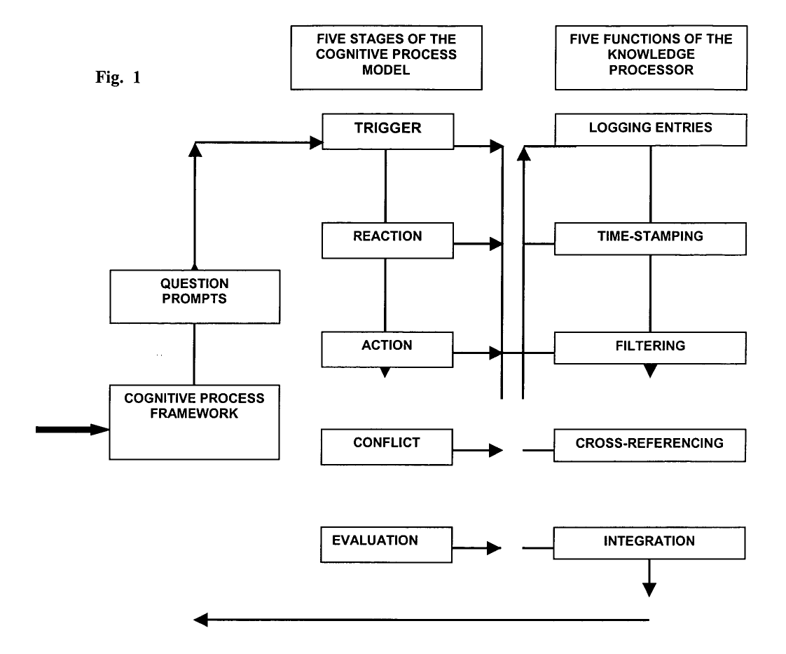

In one embodiment, as shown in FIG. 1, through its process-based information architecture the TRACE Cognitive Process Model provides a framework for soliciting, receiving, logging, filtering, and integrating input from users, independent of their discipline. The user is prompted to enter responses under a series of question prompts within each of the five phases of the TRACE cognitive process model, which are equally usable in a wide range of disciplines. The user is further prompted to select from a predefined set of general questions that organize content entries. The framework categorizes content entries into each of the five phases of the model supporting a cross-disiplinary system for knowledge management as the collaborative environment scales up.

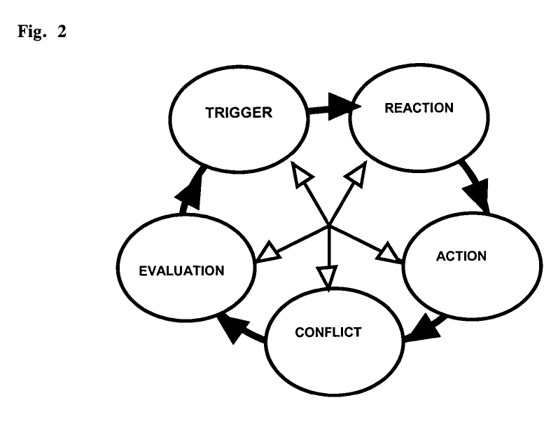

As shown in FIG. 2, the TRACE Cognitive Process Model is cyclic, giving the user flexibility to enter any stage from any other and to revisit stages as needed.

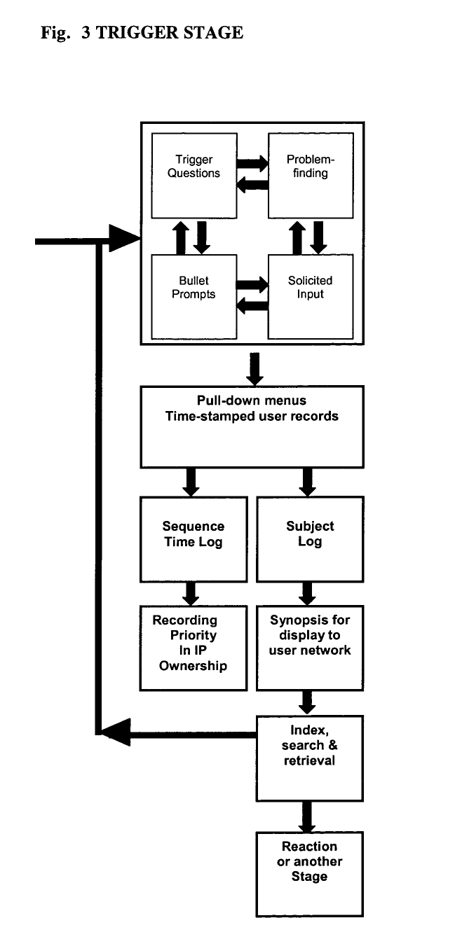

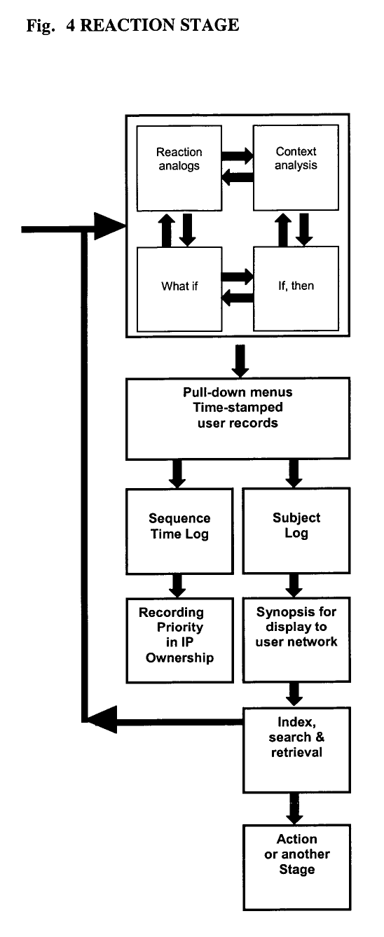

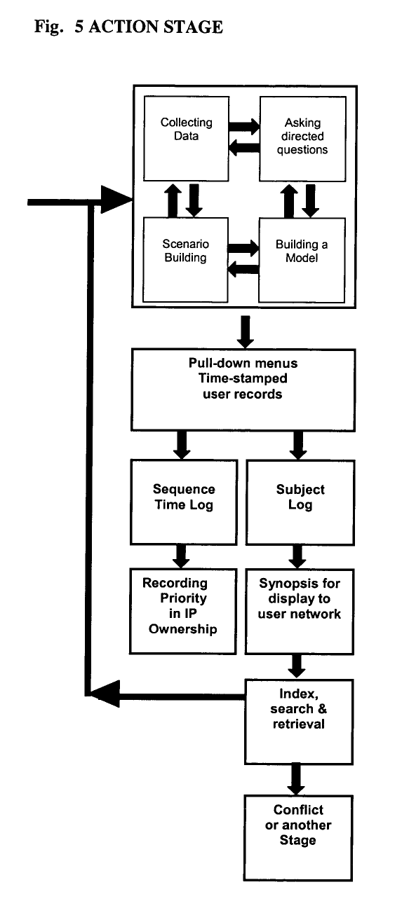

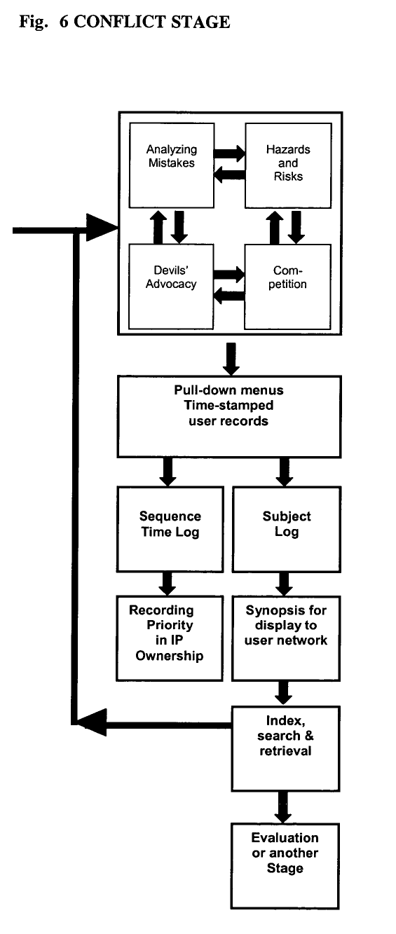

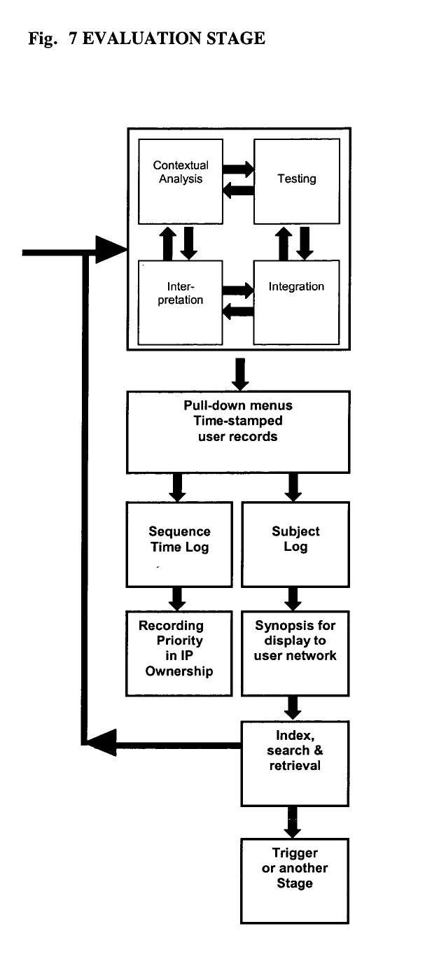

As shown in FIGS. 3-7, in the one embodiment of the invention the process framework usually consists of a series of question prompts grouped into the five TRACE cognitive model process stages. This process framework can be used independent of a computational or networked environment, but such environments provide useful facility for record-keeping and knowledge management. The process framework, with prompts to guide users through complex tasks, assures that users explore a range of options and also helps both individual users and groups to structure their thought processes for better communication and collaboration.

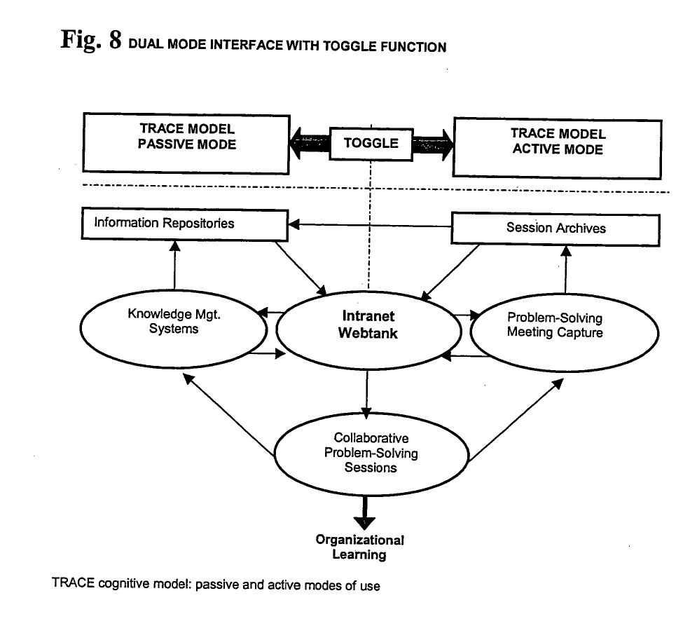

In one embodiment, as shown in FIG. 8, embedded in a webtank (think tank on the web) the TRACE cognitive model serves two complementary functions: providing process support for invention, collaborative problem-solving and authoring (active mode), and offering a knowledge management framework for information resources and project archives (passive mode). The TRACE cognitive model provides the architecture for both a brainstorming prompter (active mode) and for knowledge management and record-keeping (passive mode). Users can toggle back and forth between active and passive modes.

Because of its process-based structure, the system has broad, cross-disciplinary applicability, ranging from project development to project-based learning across disciplines. It can serve both as a process guide to support task development, and as a way to structure records after-the-fact. The TRACE Knowledge Processor can be an add-on to existing websites to augment functionality, much as search engines are add-ons; its questions can be customized for varied users in a range of collaborative environments. It provides a flexible architecture that effectively combines the knowledge base of the computer system with that of the user.

Embodiments of the present invention provide for passively and actively collecting information from and about the user, implemented either through computer software or within a collaborative web environment, which enables the development and recording of plans, programs, and project ideas. Question prompts more frequently used rise in the framework, while those seldom used gradually sink and are filtered out. The user's path through the Knowledge Processor framework is recorded and becomes part of the database of the system and can be used to study user preferences and to support updates and refinements to the system.

Data entry is simplified, and knowledge management enabled, through a framework that automatically classifies entries according to their position in a phased problem-solving process. In the data entry mode the TRACE model provides a process-based framework to structure input. In the data retrieval mode user input is logged, not only in order to retrieve data, but also for use by the embedded continuous survey function. This function profiles users in order to customize the system to their needs, refine and extend system capabilities based upon how it is used, and, where appropriate, to match users with others sharing similar interests.

The system of one embodiment, enables the user to make decisions about a task through generating questions within a structured framework. The specific questions asked may be preformulated or may be dynamically generated by a question procedure which calls up a reference procedure that uses previous responses by that user and other users with similar interest profiles. Questions and answers are kept current as the user moves through the system.

The embedded continuous survey capability can enable data gathering to be addressed from a technical perspective and/or from a content perspective. It is easier to document technical changes than to track decisions because “tracking clicks” can be automated. If data is gathered from a technical perspective, each computer-registered action can be documented and linked to the person responsible for that action. In data gathering from a content perspective each decision is documented, together with the rationale for that decision, including the alternatives that were not chosen. Quantifiable components of content assessment include who's talking to whom and for how long. Pattern-related components include clustering around documents, how strands evolve, and how key concepts emerge and move through the group, helping to determine what tasks agents can handle. An hypothesis that has an unpredicted impact on a simulation should be archived in webtank memory so that it will be available to future users.

Documentation of process events and user interaction can be linked to an assessment plan that can inform human/agent decisions about how to modify the documentation strategy and guide webtank evolution. Beyond tracking human/agent collaborative processes, webtank modifications need to be tracked. Through webtank evolution both its code and its environment will change, each change affecting its capability to respond to user needs: Is the change a bug or a constructive mutation? Methods for storing, viewing, and using performance data need to be developed to support webtank tuning, modification, and extension and to study how webtank intelligence emerges.

The present invention is intended for use in conjunction with traditional methods of query and search. When used as complementary systems, the present invention provides tools and protocols to enable large communities to aggregate and access shared information. Because of its process orientation the present invention fosters a sense of shared presence and mutual support and enables users too add content to its web environment by making knowledge-sharing coincident with knowledge development.

In one embodiment, questions and responses are displayed as text; however they may be asked and displayed in a range of ways, such as with audio or printing devices. The questions may be asked and responded to in any order preferred by the user, and new questions may be generated by the system based upon user responses and task sequencing. A range of input devices can serve as multiple tracking streams: speech, light pointers, touch screens, click records. Sensors could also be used in an immersive embodiment of the webtank. Sound tracking can provide and collect information from users. Tracking designs differ, just as individuals differ in their assessments of what is worth saving and how to file it for future retrieval. For example, how the active player defines the view impacts all other collaborators. The way the active player navigates through a scenario impacts the participation of other players and the playout of that scenario.

Use of the TRACE Cognitive Model to design a webtank that can evolve its intelligence in response to its users will not only be critical to support think tanks of the future; it is also a “terrestrial analog” for intelligent systems capabilities needed on space missions. Documentation of webtank collaborative problem-solving sessions, self-assessment of performance, and adaptive response will together support emergent intelligence in this distributed system.

The parameters of the system can be adjusted to produce more useful results. For example, Question prompts with a lot of responses can be raised in priority. System managers can modify other prompts that have been found to be less fruitful.

The user can input their profile information, along with interests. The system can use the profile information in order to select teams for projects and for other purposes.

In one embodiment, a toggle button is used. This toggle button can be an image map that allows the switching between an active, or collaboration mode, and a passive, or information mode. The active mode is provided for the user input in different structured stages, such as the five TRACE stages. The information mode can include requests to the system to find what input prior users made for similar projects. The information mode can include a search mode in which the user searches for prior user's input. In a preferred embodiment, this searching includes searching based upon a structured stage. For example, the user can search for someone who had a project with a similar trigger and then view the reaction stage information for this prior project. This information can be used on first users to modify their own reaction stage.

In one embodiment, the structured stages for a project can be displayed in a map of the connections between the stages. This can show the development of a large project through different developments.

It will be appreciated by those skilled in the art that the present invention can be embodied in other specific forms without departing from the spirit or essential characteristics thereof. The presently disclosed embodiments are therefore considered in all respects illustrative and not restricted. The scope of the invention is indicated by the appended claims rather than the foregoing description and all changes that come within the meaning and range and equivalence thereof are intended to be embraced within.

What is claimed:

1. Project development software comprising at least one display for a number of structured stages, the displays including user question prompts to receive user input, the structured stages including a trigger stage which is used to analyze problems, a reaction stage in which collects reactions to the triggers determined in the trigger stage, an action stage in which the user determines an action, a conflict stage in which feedback on the action is done, and an evaluation stage in which a final assessment of the action is done, the project development software being such that the user can move between the five stages to facilitate work on a project.

2. The project development software of claim 1, wherein the project development software includes an active mode in which the user inputs information concerning a project using the structured stages related to a project and a passive mode in which the user can search to find, for a given structured stage, input by previous users for similar projects.

3. The project development software of claim 2 wherein the user can toggle between the active and passive modes.

4. Project development software including an active mode in which the user inputs information concerning a project using a number of structured stages related to a project and a passive mode in which the user can search to find, for a given structured stage, input by previous users for similar projects.

5. The project development software of claim 4 wherein the user can toggle between the active and passive modes.

6. The project development software of claim 4 wherein the structured stages including a trigger stage which is used to analyze problems, a reaction stage in which collects reactions to the triggers determined in the trigger stage, an action stage in which the user determines an action, a conflict stage in which feedback on the action is done, and an evaluation stage in which a final assessment of the action is done.

7. The project development software of claim 6 wherein the user can move between the five stages to facilitate work on a project.
